(19) United States
(12) Patent Application Publication
(10) Pub. No.: US 2006/0036355 A1
(43) Pub. Date: Feb. 16, 2006

(54) Connector with back-up power via data link connector

(76) Inventors: David L. Schaar, Chagrin Falls, OH (US); John Bauersfeld, Solon, OH (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 10/915,101

(22) Filed: Aug. 10, 2004

(51) Int. Cl. G06F 7/00

(52) U.S. Cl. 701/1; 701/29; 701/33

(57) ABSTRACT

A portable back-up power supply system includes a data link socket on a vehicle. A connector is engageable with the data link socket. A power source is electrically connected to the connector. The power source supplies electrical power to an electronic component on the vehicle via the connector and the socket when a primary power source on the vehicle is interrupted.

### BACKGROUND

The present invention relates to an off-board electric power supply. It finds particular application in conjunction with an off-board power supply connecting to an electronic device on a vehicle via a data link connector on the vehicle and will be described with particular reference thereto. It will be appreciated, however, that the invention is also amenable to other applications.

Modem vehicles typically include a vehicle diagnostic system having one or more electronic diagnostic devices, such as control units and sensors, that monitor the status of various systems on-board the vehicle. The diagnostic devices electrically communicate with a data link connector (DLC), which is also included on-board the vehicle, via a data bus. So-called off-board devices (e.g., scan tools and code readers) are configured to connect with the vehicle diagnostic system via the DLC. The electronic diagnostic devices electrically communicate with the off-board device via the data bus and the DLC. In this manner, electronic signals indicating the status of the various vehicle systems are transmitted from the diagnostic devices to the off-board device via the data bus and the DLC. The off-board device displays and/or prints diagnostic information indicating the status of the vehicle systems.

Many of the electronic diagnostic devices include software settings that are set via the off-board device. For example, different features of the diagnostic devices may be enabled/disabled via the software settings. The operator may enable/disable a feature during the time the off-board device is communicating with the electronic diagnostic device. Then, as long as electric power is continuously supplied to the electronic diagnostic device on the vehicle, the option identifying whether the feature is enabled/disabled remains set even after communication between the electronic diagnostic device and the off-board device is interrupted by, for example, removing the off-board device from the DLC. The option often remains set even when the off-board device is re-connected to the electronic diagnostic device via the DLC. Furthermore, other computer memories (e.g., radio settings, power seat settings, power mirror settings, and other systems set by an operator or driver) on the vehicle are also maintained by a continuous supply of electric power.

As discussed above, the electronic diagnostic devices require a continuous supply of electric power to maintain selected options. Although the vehicle battery is a relatively reliable source of constant electric power, there are times when the vehicle battery fails because, for example, of a current drain (e.g., the vehicle lights were left on for an extended period of time after the motor was turned off). Furthermore, because the performance of the vehicle battery deteriorates over time, it is also necessary to periodically replace the vehicle battery before the performance is compromised to a point at which the battery does not provide the necessary power for starting the vehicle and/or maintaining the selected options in the electronic diagnostic devices.

When the vehicle battery is replaced, the original battery is electrically disconnected from the vehicle. Therefore, the electric power supplied to the electrical components on-board the vehicle is temporarily interrupted until the new battery is connected. This interruption of power is typically long enough to erase settings maintained by a continuous supply of electric power.

It is undesirable for the selected options in the electronic diagnostic devices to be reset (e.g., erased) when the vehicle battery is replaced.

### SUMMARY

In one embodiment, an off-board power supply includes a plug engageable with an on-board data link connector. A power source supplies electrical power to an on-board electronic component via the plug and the on-board data link connector.

In another embodiment, a portable back-up power supply system includes a data link socket on a vehicle. A connector is engageable with the data link socket. A power source is electrically connected to the connector. The power source supplies electrical power to an electronic component on the vehicle via the connector and the socket when a primary power source on the vehicle is interrupted.

In another embodiment, a method for supplying back-up power to an electronic component on a vehicle includes connecting a plug to a data link connector on a vehicle. The data link connector is electrically connected to the electronic component. A back-up power source is electrically connected to the plug. A primary power source is disconnected from the electronic component. Power from the back-up power source is supplied to the electronic component via the plug and the data link connector.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to exemplify the embodiments of this invention.

FIG. 1 illustrates a block diagram of an exemplary back-up power supply system in accordance with one embodiment of the present invention;

FIG. 2 illustrates the exemplary back-up power supply system in accordance with one embodiment of the present invention; and

FIG. 3 illustrates an exemplary connector in accordance with one embodiment of the present invention.

### DETAILED DESCRIPTION OF ILLUSTRATED EMBODIMENT

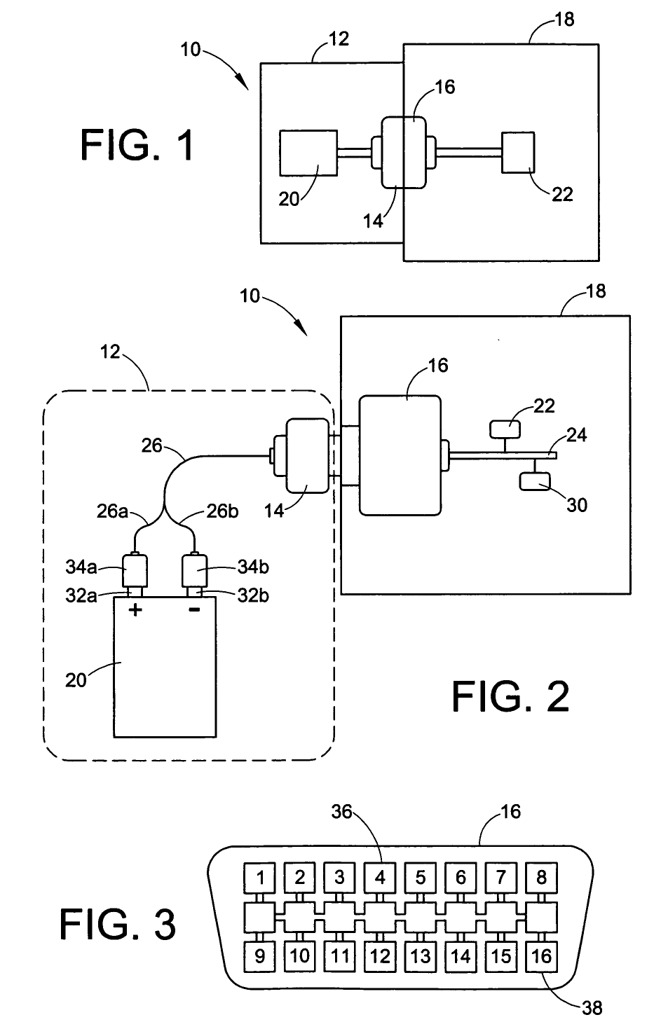

With reference to FIG. 1, an exemplary back-up power supply system 10 is illustrated in accordance with one embodiment of the present invention. The system 10 includes a power supply 12, a connector (plug) 14, and a data link connector (DLC) 16 (data link socket). The DLC 16 is on a vehicle 18. The plug 14 is engageable with the DLC 16. A power source 20 acts as a means for supplying electrical power to an electronic device or control unit (component) 22 on the vehicle 18 via the plug 14 and the DLC 16. In one embodiment, it is contemplated that the power source 20 is a battery; however, other embodiments in which the power source 20 is a solar cell, fuel cell, transformer, etc. are also contemplated.

With reference to FIG. 2, the exemplary back-up power supply system 10 is illustrated in accordance with one embodiment of the present invention. A bus 24 on the vehicle 18 electrically connects the DLC 16 with the electronic device 22 and the power supply 12 that is off-board (i.e., not located on-board the vehicle 18). The off-board power supply 12 includes a cable 26 that electrically connects the power source 20 and the plug 14. A first end of the cable 26 is electrically connected to the power source 20 and a second end of the cable 26 is electrically connected to the plug 14. The plug 14 is engageable with the DLC 16. When the plug 14 is engaged with the DLC 16, the cable 26 is electrically connected to the bus 24. Therefore, an electrical path is created between the power source 20 and the electronic device 22 via the cable 26, the plug 14, the DLC 16, and the bus 24. Because the power supply 12 may be engaged to and disengaged from the DLC 16, the power supply 12 is referred to as being portable.

The electronic device 22 includes software settings that are selected by a user through, for example, an off-board device (e.g., a scan tool or code reader) that communicates with the electronic device 22 via the DLC 16. The electronic device 22 may require a continuous supply of electrical power to maintain the software settings.

A primary power source 30 on-board the vehicle also electrically communicates with the electronic device 22 via the bus 24. During normal use, it is to be understood that the primary power source 30 supplies electrical power to the on-board electronic component 22. In this manner, the software settings in the electronic device 22 are maintained. As discussed below, the power source 20 acts as a back-up power source when the primary power source 30 is not electrically connected to the electronic component 22.

In one embodiment, the cable 26 includes a plurality of electrical conductors 26a, 26b. For example, in the exemplary embodiment of FIG. 2, the first electrical conductor 26a is electrically connected to a positive terminal 32a of the power source 20. Also, in the exemplary embodiment of FIG. 2, the second electrical conductor 26b is electrically connected to a negative (ground) terminal 32b of the power source 20. It is to be understood that the bus 24 also includes at least two (2) electrical conductors (not shown) that electrically communicate with the first and second electrical conductors 26a, 26b, respectively, of the cable 26.

In the exemplary embodiment of FIG. 2, a first coupler 34a (fastener) electrically secures the first electrical conductor 26a to the positive terminal 32a of the power source 20. A second coupler 34b (fastener) electrically secures the second electrical conductor 26b to the ground terminal 32b of the power source 20. In the exemplary embodiment of FIG. 2, the couplers 34a, 34b removably (releasably) secure the conductors 26a, 26b to the positive and ground terminals 32a, 32b, respectively, so that the power source 20 may be replaced when, for example, the electrical power stored on the power source 20 becomes drained. It is to be understood that the conductors 26a, 26b and the couplers 34a, 34b act as a means for electrically connecting the power source 20 to the DLC 16.

FIG. 3 illustrates the DLC 16 in one embodiment of the present invention. More specifically, the DLC 16 is represented as a J1962 connector. In this embodiment, the plug 14 (see FIG. 2) is designed to mate with the J1962 connector 16. A J1962 DLC 16 includes sixteen pins. Two (2) of the pins 36, 38 are typically used for carrying power. More specifically, the pin 36 (e.g., pin #4) is typically electrically connected to a positive terminal of a power source. Also, the pin 38 (e.g., pin #16) is typically electrically connected to a negative (ground) terminal of a power source. Therefore, it is to be understood that the pins 36, 38 electrically communicate with the positive and negative terminals, respectively, (not shown) of the primary power source 30.

With reference to FIGS. 2 and 3, when the plug 14 is engaged with the DLC 16, the pin 36 (e.g., pin #4) is electrically connected to the positive terminal 32a of the power source 20. Also, the pin 38 (e.g., pin #16) is electrically connected to the ground terminal 32b of the power source 20.

When it is expected that the primary power source 30 will not be able to supply power to the electronic component 22 because, for example, the primary power source 30 will be removed, the power source 20 is electrically connected to first ends of the electrical conductors 26a, 26b in the cable 26. More specifically, the electrical conductor 26a is connected to the positive terminal 32a of the power source 20, and the electrical conductor 26b is connected to the ground terminal 32b of the power source 20. Also, second ends of the cable 26 are electrically connected to the plug 14. The plug 14 is connected to the DLC 16 so that the power source 20 provides electrical power to the electronic component 22 via the cable 26, the plug 14, the DLC 16, and the bus 24.

After power is supplied to the electronic component 22 from the power source 20, the primary power source 30 may be electrically disconnected from the electronic component 22 and power to the electronic device 22 from the power source 30 is interrupted. The back-up power source 20 provides electrical power to the electronic component 22 during the time the primary power source 30 is disconnected. Once the primary power source 30 is electrically re-connected to the electronic component 22 (e.g., a new vehicle battery is installed), the plug 14 may be removed from the DLC 16 so that the power source 20 is electrically disconnected from the electronic component 22.

Although the present invention has been described in terms of supplying back-up power to an electronic component on a bus, it is to be understood that the present invention may also be used for providing back-up power to any component using power (e.g., a radio for maintaining radio settings, a power seat for maintaining power seat settings, a power mirror for maintaining mirror position settings, and other systems set by an operator or driver) on a vehicle.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

I/We claim:

1. An off-board power supply, comprising:
a plug engageable with an on-board data link connector; and
a power source for supplying electrical power to an on-board electronic component via the plug and the on-board data link connector.

2. The off-board power supply as set forth in claim 1, wherein the data link connector is a J1962 connector.

3. The off-board power supply as set forth in claim 2, wherein:
a positive contact of the power source is electrically connected to a first pin in the J1962 connector; and
a negative contact of the power source is electrically connected to a second pin in the J1962 connector.

4. The off-board power supply as set forth in claim 3, wherein:
the first pin of the J1962 connector is pin 4; and
the second pin of the J1962 connector is pin 16.

5. The off-board power supply as set forth in claim 2, wherein the plug mates with the J1962 connector.

6. The off-board power supply as set forth in claim 1, further including:
a cable electrically connecting the plug and the power source.

7. The off-board power supply as set forth in claim 6, wherein the cable includes:
a first electrical conductor connecting a first pin in the plug to a positive terminal of the power source; and
a second electrical conductor connecting a second pin in the plug to a ground terminal of the power source.

8. The off-board power supply as set forth in claim 7, further including:
a first fastener electrically connecting the first conductor to the positive terminal; and
a second fastener electrically connecting the second conductor to the ground terminal.

9. A portable back-up power supply system, comprising:
a data link socket on a vehicle;
a connector engageable with the data link socket; and
a power source, electrically connected to the connector, for supplying electrical power to an electronic component on the vehicle via the connector and the data link socket when a primary power source on the vehicle is interrupted.

10. The portable back-up power supply system as set forth in claim 9, wherein the data link socket is a J1962 connector.

11. The portable back-up power supply system as set forth in claim 10, wherein the connector mates with the data link socket.

12. The portable back-up power supply system as set forth in claim 11, wherein:
a positive terminal of the power source communicates with the electronic component via a first pin of the socket; and
a negative terminal of the power source communicates with the electronic component via a second pin of the socket.

13. The portable back-up power supply system as set forth in claim 12, wherein:
the first pin is pin 16 of the socket; and
the second pin is pin 4 of the socket.

14. The portable back-up power supply system as set forth in claim 9, further including:
a first removable fastener electrically connecting a positive terminal of the power source to the connector; and a second removable fastener electrically connecting a ground terminal of the power source to the connector.

15. A back-up power supply system, comprising:
a data link connector on a vehicle;
a power source for supplying electrical power to an electronic component on the vehicle via the data link connector; and
means for electrically connecting the power source to the data link connector.

16. The back-up power supply system as set forth in claim 15, wherein the means for electrically connecting includes:
a first electrical conductor releasably secured to both a positive terminal of the power source and to a first electrical pin of the data link connector; and
a second electrical conductor releasably secured to both a ground terminal of the power source and to a second electrical pin of the data link connector.

17. The back-up power supply system as set forth in claim 15, wherein:
the data link connector is a J1962 connector;
the first pin is pin 16 of the data link connector; and
the second pin is pin 4 of the data link connector.

18. A back-up power supply system, comprising:
a data link connector on a vehicle;
means for supplying electrical power to an electronic component on the vehicle via the data link connector; and
means for electrically connecting the power source to the data link connector.

19. A method for supplying back-up power to an electronic component on a vehicle, the method comprising:
connecting a plug to a data link connector on a vehicle, the data link connector being electrically connected to the electronic component;
disconnecting a primary power source from the electronic component; and
supplying power from a back-up power source to the electronic component via the plug and the data link connector.

20. The method for supplying back-up power to an electronic component on a vehicle as set forth in claim 19, wherein the electrically connecting the back-up power source to the plug includes:
removably connecting an electric coupler to the back-up power source, the coupler being electrically connected to plug.

21. The method for supplying back-up power to an electronic component on a vehicle as set forth in claim 19, wherein the data link connector is a J1962 connector, the connecting including:
electrically connecting a first electrical conductor of the plug, which is electrically connected to a positive terminal of the back-up power source, to a pin 16 of the data link connector; and
electrically connecting a second electrical conductor of the plug, which is electrically connected to a ground terminal of the back-up power source, to a pin 4 of the data link connector.

22. The method for supplying back-up power to an electronic component on a vehicle as set forth in claim 19, further including:
electrically connecting a back-up power source to the plug.
